(19) United States
(12) Patent Application Publication
(10) Pub. No.: US 2021/0056112 A1
(43) Pub. Date: Feb. 25, 2021

(54) METHOD AND SYSTEM FOR CONTEXT-AWARE PROVISION OF CONTENT

(71) Applicant: Oovvuu Pty Ltd., Roseville (AU)

(72) Inventor: Gregory Moore, Hillsdale (AU)

(21) Appl. No.: 16/959,396

(22) PCT Filed: Dec. 21, 2018
(86) PCT No.: PCT/AU2018/051388

§ 371 Date: Jun. 30, 2020

(30) Foreign Application Priority Data
Jan. 5, 2018 (AU) 2018900031

(51) Int. Cl. G06F 16/2457; G06F 16/908; G06F 16/9035

(52) U.S. Cl. CPC G06F 16/24575; G06F 16/24578; G06F 16/9035; G06F 16/908

(57) ABSTRACT

A system for context-aware content provision, comprising: a processor; and a computer-readable storage medium storing instructions for causing the processor to: retrieve and normalise item metadata and semantic metadata; generate, for each of a plurality of content items based on corresponding item metadata and semantic metadata, at least one of relevance, timeliness, sentiment, relation and confidence values with reference to a provision target and a reference context; and select, based on the generated at least one value, a portion of the content items for provision to the provision target in association with the reference context.

This application claims the benefit of priority from Australian Provisional Patent Application No. 2018900031, filed 5 Jan. 2018, the contents of which are incorporated herein by reference in their entirety.

### FIELD

The present disclosure relates to a method and a system for content provision, more particularly to a method and a system for context-aware content provision.

### BACKGROUND

The quality of news delivery depends on a number of factors, such as timeliness and relevance. In news delivery systems, content selection is of particular importance. Generally, news content that is more likely to appeal to an audience is favoured. While the practice of content selection can be said to provide customisation, such customisation is rather limited in extent and is intended to meet only the interests of larger audience groups. The interests of smaller audience groups often do not receive as much attention. The method of content selection must also meet the requirement of timeliness, which has become increasingly relevant as digital content becomes more prevalent.

### SUMMARY OF INVENTION

It is an object of the present disclosure to substantially overcome or at least ameliorate one or more disadvantages of existing arrangements.

According to a first aspect, there is provided a system for context-aware content provision, comprising: a processor; and a computer-readable storage medium storing instructions for causing the processor to: generate, for each of a plurality of content items based on corresponding item metadata and semantic metadata, at least one of relevance, timeliness, sentiment, relation and confidence values with reference to a provision target and a reference context; and selecting, based on the generated at least one value, a portion of the content items for provision to the provision target in association with the reference context.

The provision target may be a group of users and the reference context may include environmental metadata of at least one of national news, regional news, financial news, weather news, social media outputs and traffic updates associated with the group of users.

The provision target may be an individual user and the reference context may include user metadata associated with the individual user.

Normalising the item metadata and the semantic metadata may comprise normalising at least one of terms and scores contained therein.

Score normalisation may be based on linear scoring, and for positive scores, the normalised score may be equal to the score to be normalised divided by the highest positive range value, and for negative scores, the normalised score may be equal to the score to be normalised divided by the lowest negative range value.

Score normalisation may be based on normal distribution scoring.

The at least one of the values may be generated further based on performance-analysis data corresponding to the respective content item.

A matching score may be generated to generate each of the at least one values, the matching based upon at least one of a matching term score, a matching category score and a matching relationship score, and the processor may be caused to select the portion of the content items based on the generated matching score.

The matching term score may be modified using a weighted score associated with the content item and a weighted score for the reference context.

The matching category score may be modified using a category score associated with the content item and a category score for the reference context.

The matching relationship score may be modified using a relationship score associated with the content item and a relationship score for the reference context.

According to a second aspect, there is provided a method for context-aware content provision, comprising the steps of: retrieving and normalising item metadata and semantic metadata; generating, for each of a plurality of content items based on corresponding item metadata and semantic metadata, at least one of relevance, timeliness, sentiment, relation and confidence values with reference to a provision target and a reference context; and selecting, based on the generated at least one value, a portion of the content items for provision to the provision target in association with the reference context.

The normalising step may further comprise normalising at least one of terms and scores contained therein.

Score normalisation may be based on linear scoring, and for positive scores, the normalised score may be equal to the score to be normalised divided by the highest positive range value, and for negative scores, the normalised score may be equal to the score to be normalised divided by the lowest negative range value.

Score normalisation may be based on normal distribution scoring.

The method may further comprise the step of generating the at least one of the values based on performance-analysis data corresponding to the respective content item.

The method may further comprise the steps of generating a matching score to generate each of the at least one values, the matching score based on at least one of a matching term score, a matching category score and a matching relationship score, and selecting the portion of the content items based on the generated matching score.

The method may further comprise the step of modifying the matching term score based on a weighted score associated with the content item and a weighted score for the reference context.

The method may further comprise the step of modifying the matching category score based on a category score associated with the content item and a category score for the reference context.

The method may further comprise the step of modifying the matching relationship score based on a relationship score associated with the content item and a relationship score for the reference context.

The following provides further examples of features that may be used in various embodiments.

The reference context may provide information that allows the system to identify the provision target as belonging to a group of people, or an individual user.

Where the reference context refers to a group of people then the system will access environmental metadata about that provides additional context about the group of people as the provision target, whether it be information about their physical environs, societal status, social groupings or membership of other communities, and will include at least one of national news, regional news, financial news, weather news, individual information and traffic updates.

In the arrangement where the provision target corresponds to an individual user, the reference context may include metadata associated with the individual user. The user metadata may include coordinate information corresponding to the individual user. For example, the reference context may include news articles determined, based on the reference context represented by the user metadata, to be of particular relevance to the individual user, based on information accessible about them that could include their individual behaviour, or their social media output.

The computer-readable storage medium may further store instructions for causing the processor to normalize the item metadata and the semantic metadata. For example, normalizing the item metadata and the semantic metadata may include normalising at least one of terms and scores contained therein. Such a process of normalization reduces the risk of biased selection of content items for provision.

The portion of the content items may be selected further based on additional variables, such as performance-analysis data corresponding to the respective item. The performance-analysis data may be generated by the system and represent usage of the selected portion of the content items by the provision target.

By virtue of taking into account the item metadata, the semantic metadata, and optionally the environmental metadata and the performance-analysis data, the system and the method achieve the technical effect of improved relevance of content provision, where the selected portion of content items are of a higher relevance to the provision target within the reference context.

### BRIEF DESCRIPTION OF DRAWINGS

Example embodiments of the present disclosure are described below with reference to the accompanying drawings, of which:

FIG. 1 is a block diagram showing components of a system of an embodiment of the present invention;

FIG. 2 is a block diagram showing data communication of the system of FIG. 1 with other servers over a network according to one example embodiment;

FIG. 3 is a block diagram showing data communication of the system of FIG. 1 with other servers over a network;

FIG. 4 shows an example of sematic data for a content item; and

FIG. 5 shows an overview of a method of providing context-aware content;

### DESCRIPTION OF EMBODIMENTS

The arrangements described relate to providing context-aware content. Providing effective content selection for news systems is important. However, due to the scope of different audiences, the extent and effectiveness of customised selection of content for audiences of varying size has been limited. Determination of how to select appropriate content for a specific audience from digital files is increasingly difficult, particularly for smaller audiences. The arrangements described address a problem of how to provide a system and method that is sufficiently adaptable to allow selection of content suitable for a particular audience, irrespective of the size and composition of the audience.

In the arrangements described the target audience that content is selected for is also referred to as a provision target. The provision target can be a single person, or a group of people.

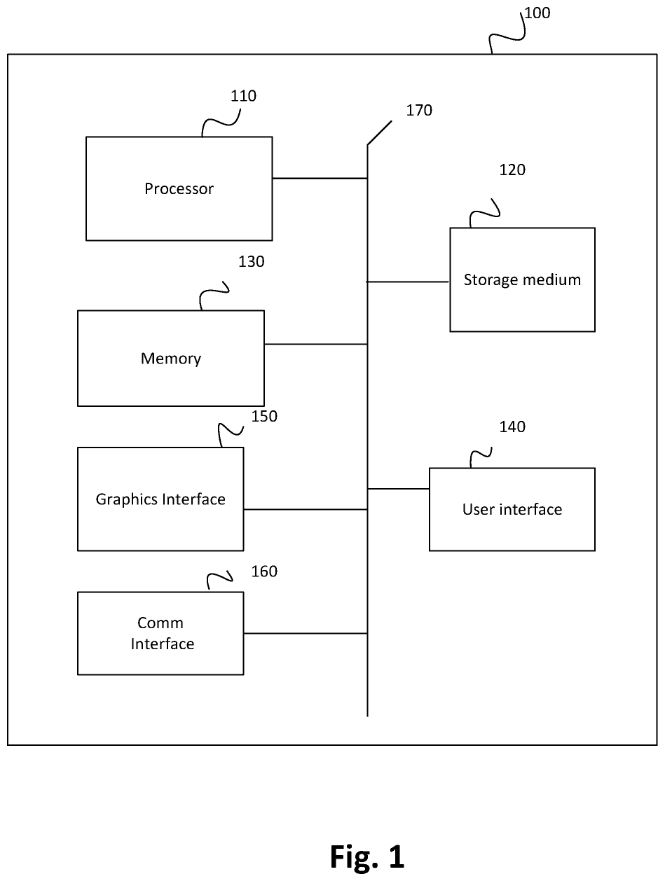

FIG. 1 shows a block diagram of a system 100 according to an example embodiment of the present invention. The system includes a processor 110, a computer-readable storage medium 120 (e.g., a hard-disk drive or a solid-state drive), a memory module 130 (e.g., a random access memory (RAM) module), a user interface 140 (e.g., a touch screen, a keyboard or a pointer device), a graphics interface 150, and a communication interface 160. The processor 110 is operatively associated with the other components 120-160 via a system bus 170.

The storage medium 120 stores instructions for causing the processor 110 to perform steps of a method according to one example embodiment of the present invention. The processor 110 in this example embodiment is operable to access item metadata, and semantic metadata corresponding to a plurality of content items via the communication interface 160 through a network (e.g., the Internet). As an example, performance-analysis data corresponding to a plurality of content items may also be accessed by the processor.

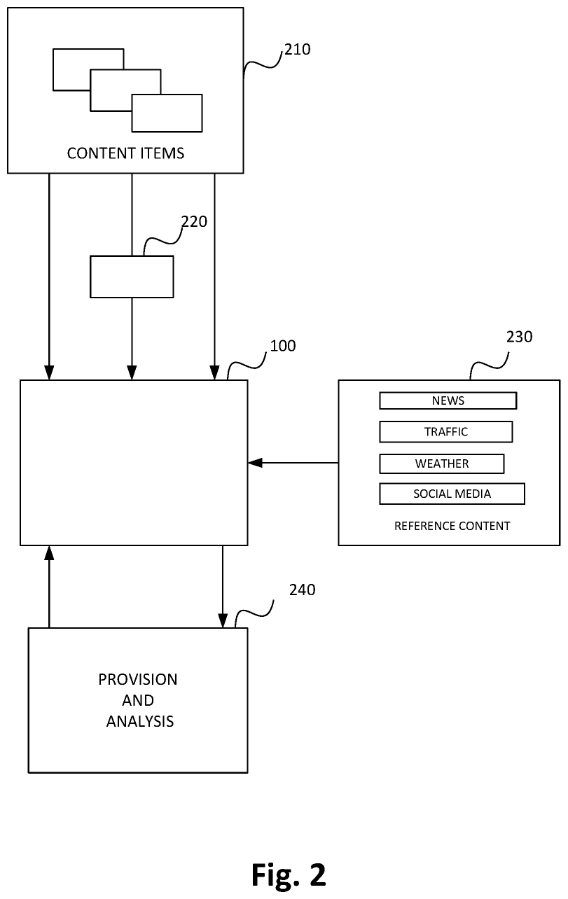

FIG. 2 is a block diagram showing an example of data communication among the system 100, a content hosting server 210, a semantic analysis server 220, a context server 230 and a content provision server 240. The servers 210, 220 and 230 execute instructions on a processor, similarly to the system 100.

The content hosting server 210 is in operative communication with the system 100 via the network, and stores the content items and the metadata associated therewith. In this embodiment, each content item contains at least one of textual information, image information (including video information) and audio information. Some of the content items may be of a commercial nature and may be regarded as advertisements. The metadata of each content item includes information such as unique identification information, date, author, publisher, and restrictions on the distribution of the respective item. In some arrangements, information regarding a language of the content item can be included in the metadata. These pieces of information collectively form the item metadata.

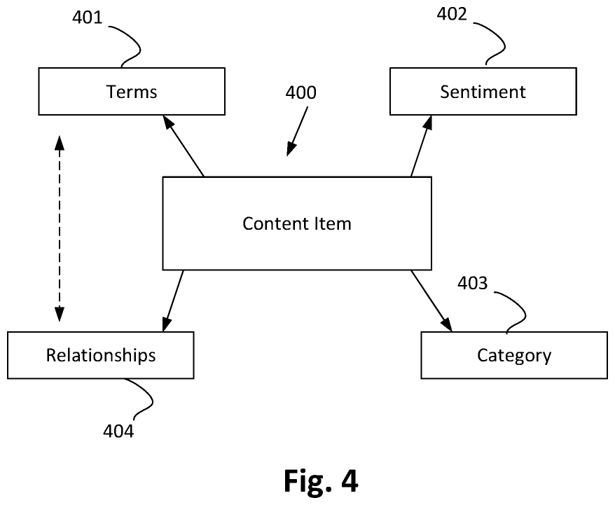

The semantic analysis server 220 analyses the content items stored on the content hosting server 210 to generate the semantic data representing semantic descriptions of the content items. The generated semantic data of each content item includes information such as “terms”, “sentiment”, “category” and “relationships”. FIG. 4 shows an example content item 400 having associated semantic content for terms 401, sentiment 402, category 403 and relationships 404. The metadata 401 to 404 can be described using JSON, XML, or other computer-understandable formats for describing objects and their inter-relationships.

“Terms” (shown as 401) are words or short phrases that describe or are included in the content item to which “Terms” are attached. Such words or short phrases are descriptive of various objects (e.g., objects of interest), ranging from people, places and things, to abstract concepts of the respective content item. Each term may have a score of confidence that is normalised to have a normalisation value within the range of 0 to 1 and may also have a relevance score similarly normalised to have a relevance value within the range of 0 to 1. Content items generally have multiple Terms. Terms can be determined using techniques such as one or more of analysing words used in textual content, recognition of words in audio or video content, and analysis of portions of the metadata relating to publisher, author or the like. Techniques such as speech-to-text, image recognition and scene segmentation can be used for video and audio content.

“Sentiment” (402) is both a scored item of its own, but is also broken down into smaller subgroupings. As its own scored item Sentiment indicates the overall tone of the content item as either positive or negative, with normalised scores ranging from −1 (most negative) to 1 (most positive) with 0 being neutral. Individual aspects of sentiment may also be broken down. In these instances, the normalised scores run from 0 to 1 indicating the level of that emotion. Examples of these subgroupings might be joy/happiness, anger or disgust. Sentiment can be determined using sentiment analysis techniques, such as analysis of words used in textual content, or words recognised in audio or video content. Techniques such as speech-to-text, image recognition and scene segmentation can be used for analysis of video and audio content

“Category” (403) is the assigned value(s) that place the content item within a commonly understood breakdown of the content according to standard news and advertising categorisations. For example, a content item assigned a category of /lifestyle/travel/spain therefore would be understood to be a content item concerned with vacationing in Spain. Content items may be assigned to more than one category. Category can be determined using techniques such as one or more of analysing words used in textual content, recognition of words in audio or video content, and analysis of portions of the metadata such as author and publisher.

“Relationships” (404) are relationships between “Terms” (e.g. people, places and things) assigned to the respective content item. Examples include familial, organisational and ownership. The normalised relationship score is between 0 and 1 for the strength of the understood relationship. Items will generally have at least one, and potentially many Relationships. A dotted line in FIG. 4 indicates that Relationships 404 are related to Terms 403. Relationships may be determined using similar techniques described determining Terms. Relationships may also be determined via referencing either internal or external datasets that provide information as to known pre-existing relationships between terms. Existing datasets providing existing relationships can be used. Additionally or alternatively, the datasets can be developed over time based upon use of the system 100.

The content items may be in different languages to each other or to a default language for content of the system 100. Reference context may also be associated with a language. Language may be determined from content metadata and/or by analysis of text or recognition of words spoken in audio or video content. When one or more of the reference context and the content items are in different languages, the system 100 uses automated third-party translation systems to bring both the reference context and the content items into a common language. The common language may be the same language as one of the reference context or the content items, or may be a third language (such as the default language or a language associated with the provision target). Language can relate to a category of a content item or a term of a content item.

In this embodiment, the semantic data accessed by the processor 110 are normalised, where terms and scores contained therein are normalised.

“Term normalisation” reduces the risk of similar terms referring to a same object or entity being unintentionally or inadvertently considered to relate to different objects or entities. For example, the terms “Barack Obama” and “President Obama”, once normalised, are considered to be the same term. Where terms referring to a same object are present for a content item, the highest normalisation value is selected to be the score of confidence.

“Score normalisation” is where all assigned scores are reinterpreted into a standard range from potentially differing inputs. Where the input ranges from 0-10 but the normalised range is 0-1 the scores will be reinterpreted into the new range. If the initial range is a linear scale the input score is divided by the highest value in the range, in this case 10. If the input range is a non-linear scale the input score is deduced using any suitable method of mathematical calculation for that type of scale.

The performance-analysis data of each content item is generated from a plurality of sets of statistical data descriptive of interaction of the provision target with the selected content items. For example, the performance-analysis data may include a value corresponding to the number of times each selected content item is viewed by the provision target.

The context server 230 serves as a source of context information which, in this embodiment, includes, but is not limited to national news, regional news, financial news, weather news, individual information and traffic updates. The system 100 receives the context information from the context server 230 and determines a reference context in accordance with the received context information. In embodiments where the provision target is an individual user, the context information received from the context server 230 may define a reference context including user metadata (e.g., a social network profile) and environmental metadata (e.g., geographical coordinate information) of the individual user. The user metadata may be generated according to interaction of the individual user with various services, and may be collected directly or indirectly from third party services. The user metadata may correspond to content items viewed by the individual user, viewing durations, and demographic information in relation to the individual user. As described below, environmental metadata can be used if the provision target is a group.

The content provision server 240 is operable to provide, from the content hosting server 210, a portion of the content items selected by the system 100 in association with the reference context to a provision target. For example, the reference context may be determined by the system, based on the inputs from the context server (230). The content provision server 240 is further operable to perform traffic analysis with respect to the provision target and provide a result of the traffic analysis to the system 100 for optimisation. That is, the performance-analysis data is generated by the content provision server 240 in this embodiment. The provision target may be determined by the system 100, based on inputs from the context server, and individual user information passed by the user's browser/system. The performance-analysis data is utilised in selecting content items, as described below.

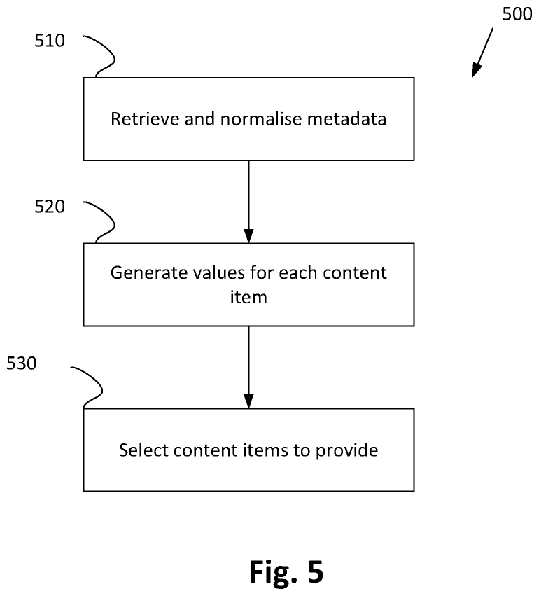

Steps according to an embodiment of the method performed by the processor 110 are described below. The steps performed by the processor 110 are shown as a method 500 in FIG. 5. The method 500 may be implemented by an application stored in the memory 130 and controlled in execution by the processor 110 for example.

The method 500 starts at a first step 510. In the first step, the processor 110 retrieves and normalises item metadata and semantic metadata. Normalising the item metadata and the semantic metadata typically comprises normalising at least one of terms and scores contained therein to ensure that different scoring systems can be made mathematically compatible. During the normalisation all scores from different sources are transformed so that the total range that a score may fall within is the same. Typically, all scores that are to be compared to each other are transformed so that their values fall between 0 and 1.0

The method 500 continues from step 510 to a second step, step 520. In the second step, the processor 110 generates, for each of the content items based on the corresponding normalised metadata, semantic data and meta-analysis data, at least one of relevance, timeliness, sentiment, relation and confidence values with reference to the provision target and the reference context. Effectively, each value generated reflects a measure of one of relevance, timeliness, sentiment, relation and confidence with reference to the provision target and the reference context. The provision target is a target individual or audience group to whom a selected portion of the content items is to be provided within or in association with the reference context. As discussed above, the reference context is defined by the processor 100 with reference to context information received from the context server 230.

The method 500 continues from step 520 to a third step 530. In the third step of the method, the processor 110 selects, based on the at least one of the values, a portion of the content items for provision to the provision target in association with the reference context. In this embodiment, the system 100 provides identification information (e.g., identification numbers) of the content items of the selected portion to the content provision server 240, which in turn retrieves and provides the corresponding content items from the content hosting server 210 to the provision target.

In one example scenario, the reference context relates to a piece of news concerning a diplomatic event in which the president of a guest country visits a host country for an international forum (e.g., the G20). In this scenario, a content item (e.g., a video) showing a past visit to the host country by the president of the guest country has a relevance value higher than that of another content item showing a less relevant or unrelated content. Where two content items (e.g., videos) respectively show past and current visits by the president to the host country, the content item corresponding to the current visit has a timeliness value higher (generated at step 520) than that of the content item corresponding to the past visit. Where two content items (e.g. videos) show the same visit by the president to a host country, the coverage which is closest in tone and sentiment (e.g. the coverage is positive, moderate, or negatively phrased) to the reference context will have a higher sentiment value generated at step 520. Where nationals of one of the participating countries are the provision target, the relation value generated at step 520 is high; conversely, where nationals of a non-participating country are the provision target, the relation value is low. The confidence value generated at step 520 is the degree to which the system is confident that a score, whether it is relevance, timeliness, sentiment or relation, may be used as a modifier to those scores rather than being used as a score on its own in this context. For example, with very high confidence scores, (over 0.85) the score may remain unmodified, with very low confidence scores (under 0.35) the system may reject the use of that score altogether as not having a valid level of confidence. Scores in between may be used as a multiplier to reduce the level of impact of a score to appropriately reflect the level of confidence.

The system 100 uses the arrangements described to select a portion of the content items at step 530. If the metadata retrieved at step 510 indicates different languages are present in the content items, the selected content items can be translated into the desired output language, for example by use of an appropriate third-party translation service.

Other alternative embodiments and features are described as follows.

In another embodiment the process is extended to a provision target of a group of users and the reference context relates to at least one of national news, regional news, financial news, weather news, social media outputs and traffic updates.

In this instance the processor 100 will retrieve from the context server (230) environmental metadata related to the provision target based on their membership of a broad group. This group may be location based (e.g. everyone in Sydney, or Australia), based on membership of a broad socio-economic or demographic group (e.g. men, or people aged under 20 years old), based on usage or membership of an application, platform or server (e.g. all users of Twitter) or any other broad grouping on which environmental metadata can be accessed. At least one, but any higher of different groupings may be used in this instance.

To continue the example scenario where the reference context relates to a piece of news concerning a diplomatic event in which the president of a guest country visits a host country for an international forum (e.g., the G20). A content item that frames the visit in terms of its impact with regard to the location of the provision target will have a higher score than one that does not (e.g. if the provision target is in the group of people that are physically located in Australia, then an item that refers to the impacts on Australia of the visit). Alternately if an aspect of the trip were more highly covered in the news media in Australia, than a context item that included that aspect would also be scored higher if the provision target is the group of people located within the territory.

Alternately if the provision target is a user of a particular social media platform, the content item that most closely matches the format of that platform will be favoured (e.g. Twitter would favour shorter content, Facebook would favour longer content).

In a further embodiment the provision target is an individual user and the reference context includes user metadata associated with that individual user. This user metadata may be accessed via the context server if information about the user has already been collected, or it may be provided as part of the reference context. This may include individual user behaviour that established preferences, or narrow demographic data known about the user.

A content item with semantic or item metadata that more closely matches the observed behaviour of the user will be favoured by the system 100 at step 530 over a content item that does not.

As an example, if a user has evidenced behaviour of a preference for watching content items that have item metadata that identifies it as belonging to a particular publisher (by for instance always watching the entire length of the content item), then any content item that also contains that item metadata will be given a higher value than one that does not. If a user has displayed an interest in a topic, by publishing material about that topic on social media platforms, then content items that refer to that topic will be given a higher value at step 520.

A further embodiment references at least one of the values that has been generated based on performance-analysis data corresponding to the respective content item. Typical types of values would include at least one of the number of times played, the total amount in minutes the content was watched across all user, the total amount of revenue the content item has generated, and averages and variants of these metrics. These values may be for the totality of viewing of the content, or may be restricted in scope to only include values relevant to the reference context.

A content item with higher performance values with regard to the reference context in performance metadata will similarly allocated higher values at step 520 than content items with lower values.

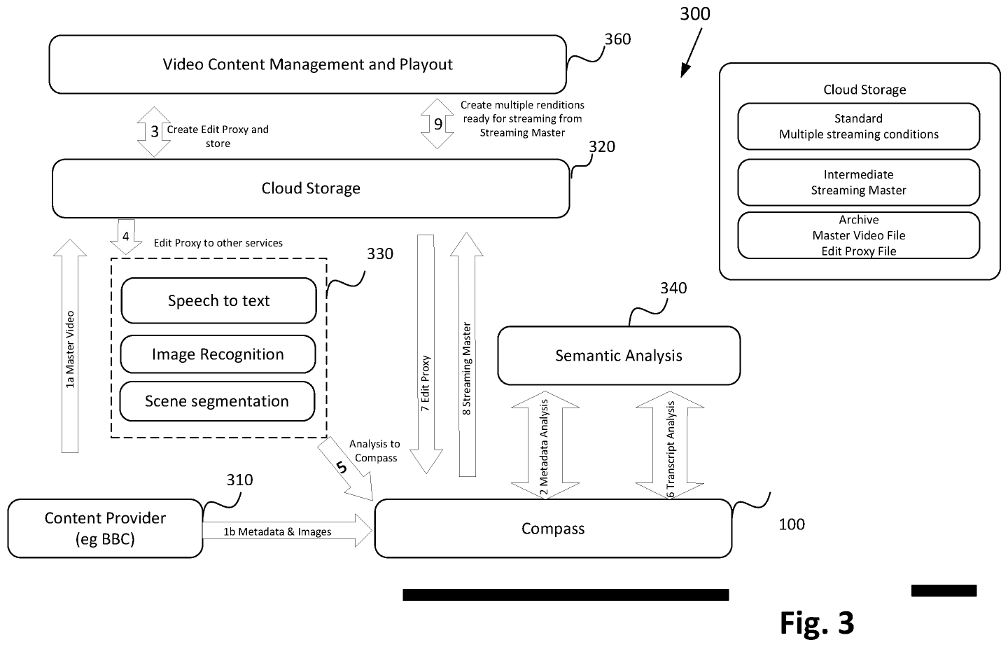

FIG. 3 shows a block diagram illustrating a process of data flow 300 between the system 100 of FIG. 1 and other network entities for item ingestion and analysis, according to another example embodiment. Steps of the process 300 are described below.

In a first step, a content provider 310 (e.g., a publisher) sends a master video to a storage device 320, which may be a cloud storage managed by the system 100, and textual metadata and associated promotional images to the system 100. The content provider 310 corresponds to the provider 210 of FIG. 2. The storage device 320 corresponds to the storage medium 120 of FIG. 2.

In a second step, the textual metadata is received, cleansed and formatted by the system 100 to facilitate analysis by a semantic analysis engine 340. A result of analysis by the semantic analysis engine 340 is stored in the system 100, for example in the storage medium 120. The semantic analysis engine 340 corresponds to the semantic server 220 of FIG. 2.

In a third step, a video transcoding service 360 transcodes the master video received by the storage device 320. A corresponding Edit Proxy (e.g. 10 Mbps video-8 GB H264 .mp4) is stored in the storage device 320.

In a fourth step, a proxy analysis engine 330 performs speech-to-text, image recognition and scene segmentation analyses on the Edit Proxy of the master video.

In a fifth step, the system 100 receives a result of the analysis performed by the proxy analysis engine 330.

In a sixth step, the system 100 provides a speed-to-text transcript to a semantic analysis engine 340 based on the result of the analysis.

In a seventh step, the system 100 retrieves the Edit Proxy of the master video.

In an eighth step, the system 100 creates a streaming master (eg 5 Mbps H264 .mp4) based on Edit Proxy and stores the created streaming master in the storage device 320. The Master video and the Edit Proxy are then archived in the storage device 320.

In a ninth step, the streaming master is used to create streaming ready renditions that are then stored in the storage device 320. The streaming master is then archived in the storage device 320.

The method 500 receives operates to receive content from a content provider (310 in FIG. 3 or 210 is FIG. 2) at step 510. Semantic and transcript analysis received at step 510 can be obtained as a result of operation of steps 2 and 6 of FIG. 3. The step 530 operates to select one or more of the content items to be provided to the provision target.

The selection at step 530 relates to one or more content items. Identification of the selected content items is provided to the playout system (360) in some implementations. In addition to data identifying the selected content items, reference context and/or information (for example demographic information) regarding the provision target can be provided to the playout system 360. The reference context and/or information regarding the provision target can be used at 360 to select a particular rendition or version of the content item for the target. For example, the playback system 360 can select one or more renditions created at step 9 of FIG. 3 Alternatively, the content item selection may be provided directly to the provider 310 at step 530. The content selection can also include reference context or information regarding the provision target to allow a specific version of the content to be provided to the target. In either implementation, whether using the playback system 360 or the content provider 310 the selection results in display of the selected content item(s) to the provision target.

Examples of various normalisation processes, score determinations and weighting algorithms are now provided. The normalisation processes, score determinations and weighting algorithms can be implemented at step 510 of the method 500. Normalising operates to allow different scoring systems to be made mathematically compatible. In the arrangements described, scores from different sources can be transformed so that the total range that a score may fall within is the same. Typically, all scores that are to be compared to each other are transformed so that their values fall between 0 and 1.0. In some implementations, score normalisation may be utilised using mathematical algorithms.

Score normalisation may be carried out as follows. For linear scoring, where the scores are positive, the normalised score may be calculated by dividing the positive score by the highest positive range value. Also for linear scoring, where the scores are negative, the normalised score may be calculated by dividing the negative score by the lowest negative range value. For normally distributed scoring, standard normal curve statistics and transformations may be used to create standardised scores.

For confidence and relevance scores, if the process used to analyse Terms returns either confidence scores, or relevance scores, but not both, then that score continues as the normalised score for the term. If the process used to analyse Terms returns both confidence and relevance scores, then the confidence and relevance scores are multiplied together to become the normalised score for the term.

All terms used in the matching process are weighted. The weighted score=the normalised score*type weighting. Weightings will vary in each application of the process; however their relative values may be derived from an iterative review of their effectiveness in the matching process. Weightings will not fall outside the range 0.5-1.5. An example table of type weighting is as follows:

TABLE 1
Type Weighting

| Term type | Weighting |
|---|---|
| Person | 1.3 |
| Keyword | 0.75 |
| Place | 1.25 |
| Concept | 1.0 |

If a term has multiple weightings only the highest weighting is used. A weighted score may be outside the original normalised range.

For Term normalisation, the lists of terms for each content item and the reference context are normalised. For a group of terms that have the same effective meaning, the highest weighted term within the grouping is used as the score and attached to the parent of the group. An example is provided as follows:

TABLE 2
Term normalisation

| Terms | Weighted Score |
|---|---|
| Barack Obama (parent term) | |
| Obama | 0.8 |
| President Obama | 0.75 |
| B. Obama* | 1.2 |

In the above example the term Barack Obama with a score of 1.2 would be used in the matching process.

Execution of step 520 comprises generating values for at least one of relevance, timeliness, sentiment, relation and confidence values. In some arrangements, generating the values comprises generating a matching score. For matching score generation, where a content item has a normalised term that is the same as one that has been determined for the reference context, a matching term score is generated or modified.

Matching term score=weighted score for content item*weighted score for reference context. The sum total of all these matching scores becomes the total matching term score.

Where a content item has a category that is the same as one that has been determined for the reference context a matching category score is generated or modified, where matching category score=category score for content item*category score for reference context. The sum total of all these matching scores becomes the total matching category score.

Where a content item has a relationship that is the same as one that has been determined for the reference context, a matching relationship score is generated or modified, where matching relationship score=score for that relationship for content item*score for that relationship for reference context. The sum total of all these matching relationship scores becomes the total matching relationship score.

The total matching score is the sum of at least one of the total matching term score, total matching category score, and total matching relationship score.

Where sentiment scores are used in the process, they are used as a multiplier on the Total Matching Score. The sentiment multiplier is worked out as follows.
The higher sentiment score is subtracted from the lower sentiment score;
A value of one is added to the result of the above step;
The result of the above step is multiplied by a number that may be different in variations of the process, to increase or limit the effect of sentiment on the final outcome. However, this multiplier number should be in the range of 0.1-0.35.
Finally, a value of one is added to create a final sentiment multiplier.

The Total Matching score is multiplied by the final sentiment multiplier.

Where 0.25 is used for the sentiment effect the formula would therefore be, for example:

(((Lower Score−Higher Score)+1)*0.25)+1=Sentiment Multiplier.

Where individual sentiment types are used (e.g. joy, disgust etc.) their multipliers may be added together before being applied to the Total Matching score. However, much lower sentiment effect scores may be used, typically being an equal proportion of what would be used as the sentiment effect if only the parent sentiment score is being used. Where individual sentiment types are being used the parent sentiment multiplier may not be used. For example, if five sentiment types are being used, then rather than 0.25 being used as the sentiment effect, 0.25/5=0.05 may be used for each individual sentiment effect.

Where performance-analysis metadata is available and to be used a set of performance bands is established for each publisher. Typically, there would be six bands that content will fall into based on the performance of that content item on the publisher's systems.

Each band provides a different multiplier to be applied to the Total Matching Score. Each band will contain a number of different elements pertaining to available metrics, and a content item will be regarded as belonging to the highest band that they meet the required target for.

An example of banding is as follows:

TABLE 3
Banding and multipliers

| Band | Streams | Ave Duration | | Multiplier |
|---|---|---|---|---|
| Band 1 | >10 Mil | Over 32 | min | 1.25 |
| Band 2 | 1 mil to 9.9 mil | up to 32 | min | 1.20 |
| Band 3 | 100,000 to 999,999 | up to 24 | min | 1.15 |
| Band 4 | 10,000 to 99,999 | up to 16 | min | 1.1 |
| Band 5 | 1,000 to 9,999 | up to 8 | min | 1.05 |
| Band 6 | <1000 | <4 | min | 1 |

In this example, a content item with 2 min average duration, but 4 million streams would receive a multiplier of 1.2. An item with 23 min duration, but only 100 streams would receive a multiplier of 1.15.

Additional banding groups are determined as needed when they are to be used as they pertain to the reference context when it refers to a group of people. Those bands may be implemented depending on the source of environmental metadata that is available around that group of people, however some examples are:
Group performance metadata—similar to performance-analysis metadata, if metadata is available for the group then separate bands for that audience segment may be used instead of the broader metadata.
Regional & national news—regional news inputs may be analysed to generate a list of the highest ranking terms. Typically, this will be a list of around 20 terms that will reflect the most important topics in the news in that region. This list of terms will be compared to the list of terms for each content item. The number of terms that a content item contains that are the same as highest regional terms will be used to place it in a band. The bands will have progressively higher multipliers in line with higher numbers of matching terms. An example of this would be:

TABLE 4
Bands and multipliers based on matching terms

| Band | Number of matching terms | Multiplier |
|---|---|---|
| Band 1 | >10 | 1.25 |
| Band 2 | 6-9 | 1.20 |
| Band 3 | 3-5 | 1.15 |
| Band 4 | 1-2 | 1.1 |
| Band 5 | 0 | 1.0 |

Aggregated social media—social media aggregations (trends, hashtags) inputs may be analysed to generate a list of the highest ranking terms. Typically, this will be a list of around 20 terms that will reflect the most important topics in social media in that region. This list of terms will be compared to the list of terms for each content item. The number of terms that a content item contains that are the same as highest social media terms will be used to place it in a band. The bands will have progressively higher multipliers in line with higher numbers of matching terms. (See the regional and national news for an example of this type of banding.)
Weather news—weather metadata may be used to assess whether the weather is likely to encourage people to stay indoors, and potentially consume more video. Content items may be banded to reflect this, where in inclement weather, video with longer duration may be preferenced, and in sunny weather where more people might be expected to be outdoors, shorter content may be preferenced with higher multipliers.
Traffic News—similar to weather, video with higher durations may be preferenced during commute times when heavy traffic conditions are reported, and more moderate durations when traffic is reported to be flowing smoothly.
Financial News—Bands may be implemented across two broad areas. Firstly, in times of good economic news, content items pertaining to luxury goods, travel and similar genres may be banded higher, and vice versa in economically poor times. Also, content with happy sentiment ratings may be banded higher in times of economic uncertainty.

Bandings may be applied to individuals where known instead of as part of a group above, with the following exceptions:
Social media may be analysed pertaining to the individual's social media output, and banded for the individual's output.
Performance metadata—Group or overall performance metadata may be used. However additional banding for each individual may be applied based on their past behaviour when interacting with content items.

Therefore, according to the various embodiments, one or more items of context-aware content (in the form of streaming ready renditions) is subsequently made available for provision to users (provision targets). The process by which the content is made context-aware (as described earlier) enables more relevant content to be made available to users based on the interest associated with smaller audience groups than was previously made available.

The various processes and system described above may also operate as follows.

The reference context may be received from the requesting party by the processor 110 via the network interface. The reference item includes the item itself, and the necessary item metadata from the requesting party.

Referring to FIG. 3, the storage medium 320 may be checked to ascertain if the item received at the first step has been previously processed. If an item has not been processed, the item may be sent to the system 100 for processing. If the item has been processed, then the details of that previous processing may be compared to a set of rules to determine if the item should be reprocessed. These rules may include time passed since last processing, extent of change in the item if any, and whether an override ‘force reprocess’ request has been passed with the item to the processor. If the item does not require reprocessing the processor may retrieve the results of the previous processing from storage and retains in memory for the next stage of the process.

If an item is to be processed the following procedure may be used. The item metadata that has been provided for the item may be first stored in the storage medium. The item itself may be transformed to meet the specifications required to be processed by the various semantic understanding service(s) that are being used to generate the semantic metadata. The transformed item may then be transferred to the semantic understanding services via the network interface. The resultant output from the semantic understanding service received by the processor via the network interface may then be normalised to this system's standard ranges for the applicable type of score by the processor. These results may be retained in memory for the next step, but may also be stored in the storage medium.

The processor may then retrieve from storage the semantic, item, and performance-analysis metadata of any content items that have any number of terms common with the reference context.

In the first instance of the process the item metadata of the retrieved content items may be checked to ensure that the content items are valid to be distributed to the requesting party. Any content items that are not valid to be distributed due to restrictions or rules may be excluded from the list of content items and may play no further part in the process.

For each of the content items, the corresponding semantic metadata may be compared to the semantic metadata of the reference context.

An initial score may be generated by the application of an algorithm to each Term, and each Relationship, that is common between the reference context and the content items. At step 530 a score for each matching Term may be generated, weighted based on algorithmic criteria, and then added to generate a total matching score for each content item. Rules may be used to exclude a Term from being added to the score if:
The reference context score for that term falls below a prescribed value; or
The content item score for that term falls below a prescribed value; or
After the application of the algorithm the resultant score falls below a prescribed value

That matching score for each content item may then be further modified at step 530 by applying weights to the matching score based on the similarly of Category and Sentiment elements of semantic metadata between the reference context and each individual content item. Those weights may be multipliers that reflect the similarity between the elements with multipliers ranging from 2 being the maximum that may be applied for a very strong match, to 0.5 for a very weak or non-existent match.

The item metadata for each of the content items may then be further analysed and compared to rules that may apply further weighting to the matching scores for each individual content item. The system 100 may allow for the definition of bespoke rules for each requesting party. The most common rule applied to the item metadata is to use the age of the content item to modify the score. The normal range for this type of timeliness rating may range from a multiplier of 2 for very recent items, to low of 0.5 for items that are not regarded as timely.

Items rules may be used to exclude content items from the list for failing to meet minimum criteria. Examples of these might be:
Failure of a minimum number of terms being added to the score for a content item
Failure to reach a prescribed minimum score for the content item
Failure of a content item to meet a prescribed minimum number of matching or similar Categories to the reference context

The list of content items may be ranked from highest to lowest according to the scores and may at this stage be returned to the requesting party via the network interface, and this is also recorded in the storage medium. The system may provide identification information (e.g., identification numbers) of the content items of the selected portion to the content provision server, which in turn may retrieve and provide the corresponding content items from the content hosting server to the provision target. It is possible due to the application of rules and exclusions for no content items to be matched.

In the second instance of this process the list of content items may undergo further weightings based on performance-analysis data before being returned to the requesting party.

In this instance the performance-analysis data for each content item may be compared across multiple elements. A standard list of elements may include video plays, average duration, total duration, ads created, gross revenue, revenue per play. The requesting party may define which of these elements should be used, and what priority to apply them in this instance.

For the elements of performance-analysis metadata to be used a weighting may be applied to each content item based on the value of each element. The value may be compared to a table of banded values that determines the appropriate multiplier. The total maximum multipliers that should be applied in this step should not exceed 1.5, so the multipliers for each element may be partly dependant on the number of elements to be used.

Once the multipliers for each element have been established they may be applied to the scores for each content item in the list.

Once again, the list of content items may then be ranked from highest to lowest according to the scores and can at this stage be returned to the requesting party via the network interface, and this may also be recorded in the storage medium. The system 100 may at step 530 provide identification information (e.g., identification numbers) of the content items of the selected portion to the content provision server, which in turn may retrieve and provide the corresponding content items from the content hosting server to the provision target.

In the third instance of this process the list of content items may undergo further weightings based on environmental metadata before being returned to the requesting party.

In this instance the reference context may provide additional information about the geographical location of the user to the processor that can be then used to generate additional weightings to content items based on item, and semantic metadata.

The processor may access the context server and receive the environmental metadata relevant to the location provided by the reference context. Each element of the environmental metadata may provide weightings to be applied to each content item, based on the content item's item, semantic, and performance metadata.

These weightings may be applied to each content item as per previous instances, the list reordered based on the news scores and can be returned to the requesting party.

In the fourth instance of this process the list of content items may undergo further weightings based on user metadata before being returned to the requesting party.

In this instance the reference context may provide user information to the processor that can be then used to generate additional weightings to content items based on item, semantic, and the user's metadata. This may be used in concert with or in place of the third instance.

Information about the users propensity to interact with certain types of content, and the length of that interaction, their demographic information and other information pertinent to the user as an individual, such as their social media output, may be used to create additional weightings based on their demonstrated interest on similar material.

These weightings may be applied to each content item as per previous instances, the list reordered based on the news scores and can be returned to the requesting party.

Weighting may also be based upon language. Similar to other weightings, relative similarities between languages may be used as a weighting when matching content between different languages. Whilst all weightings would reduce the overall score for items that are of different languages, the proportion of that weighting would be based on the relative similarities of the languages.

Some languages have very similar constructions, share words and are spoken in similar areas, and may only be weighted slightly as speakers of one language would have a good sense of the content due to those linguistic relationships. Spanish and Portuguese provide an example of languages having similar constructions and shared words.

However, languages that could be spoken in the same region, but are linguistically quite different are more heavily weighted against. For example, Hindi and Punjabi would have relatively low weighting.

In some implementations. weighting associated with languages also takes into account cultural aspects of language acquisition, and demographic information about languages within communities. Accordingly, the weighting from one language to another (language A to language B) could be relatively low, but weighting in the opposite direction (from B to A) could be relatively high. Changes in weight depending on direction of translation could occur where one language is spoken by a relatively small community, but all speakers of that community are fluent in another language, for example English. In this instance, English content items would only receive a small negative weighting, or none at all to when being matched to that language, but content items in that language would receive a large negative weighting when being matched to an English reference context.

The arrangements described are applicable to the computer and data processing industries and particularly for the advertising and content provision industries.

In using metadata associated with content item and generating values for one or more metrics such as relevance, timeliness, sentiment, relation and confidence, the arrangements described allow suitable context-aware content to be provided to the provision target. In using the generated values relating to the content items themselves to select the content, suitable content can be provided regardless of the size of the provision target. Further, selection based on the generated values allows a timely approach to providing content. If the metadata associated with the content changes, the values can be updated can be updated and selection of content made accordingly.

The foregoing describes only some embodiments of the present invention, and modifications and/or changes can be made thereto without departing from the scope and spirit of the invention, the embodiments being illustrative and not restrictive

1. A system for context-aware content provision, comprising:
a processor; and
a computer-readable storage medium storing instructions for causing the processor to:
retrieve and normalise item metadata and semantic metadata;
generate, for each of a plurality of content items based on corresponding item metadata and semantic metadata, at least one of relevance, timeliness, sentiment, relation and confidence values with reference to a provision target and a reference context; and
select, based on the generated at least one value, a portion of the content items for provision to the provision target in association with the reference context.

2. The system of claim 1, wherein the provision target is a group of users and the reference context includes environmental metadata of at least one of national news, regional news, financial news, weather news, social media outputs and traffic updates associated with the group of users.

3. The system of claim 1 or 2, wherein the provision target is an individual user and the reference context includes user metadata associated with the individual user.

4. The system of claim 1, wherein normalising the item metadata and the semantic metadata comprises normalising at least one of terms and scores contained therein.

5. The system of claim 4, wherein score normalisation is based on linear scoring, and for positive scores, the normalised score is equal to the score to be normalised divided by the highest positive range value, and for negative scores, the normalised score is equal to the score to be normalised divided by the lowest negative range value.

6. The system of claim 4, wherein score normalisation is based on normal distribution scoring.

7. The system of any one of the preceding claims, wherein the at least one of the values is generated further based on performance-analysis data corresponding to the respective content item.

8. The system of claim 1, wherein a matching score is generated to generate each of the at least one values, the matching score based upon at least one of a matching term score, a matching category score and a matching relationship score, and the processor is caused to select the portion of the content items based on the generated matching score.

9. The system of claim 8, wherein the matching term score is modified using a weighted score associated with the content item and a weighted score for the reference context.

10. The system of claim 8, wherein the matching category score modified using a category score associated with the content item and a category score for the reference context.

11. The system of claim 8, wherein the matching relationship score is modified using a relationship score associated with the content item and a relationship score for the reference context.

12. A method for context-aware content provision, comprising the steps of:
retrieving and normalising item metadata and semantic metadata;
generating, for each of a plurality of content items based on corresponding item metadata and semantic metadata, at least one of relevance, timeliness, sentiment, relation and confidence values with reference to a provision target and a reference context; and
selecting, based on the generated at least one value, a portion of the content items for provision to the provision target in association with the reference context.

13. The method of claim 12, wherein the normalising step further comprises normalising at least one of terms and scores contained therein.

14. The method of claim 13, wherein score normalisation is based on linear scoring, and for positive scores, the normalised score is equal to the score to be normalised divided by the highest positive range value, and for negative scores, the normalised score is equal to the score to be normalised divided by the lowest negative range value.

15. The method of claim 13, wherein score normalisation is based on normal distribution scoring.

16. The method of any one of claims 13 to 15, further comprising the step of generating the at least one of the values based on performance-analysis data corresponding to the respective content item.

17. The method of claim 13, further comprising the steps of generating a matching score to generate each of the at least one values, the matching score based upon at least one of a matching term score, a matching category score or a matching relationship score, and selecting the portion of the content items based on the generated matching score.

18. The method of claim 17, further comprising the step of modifying the matching term score based on a weighted score associated with the content item and a weighted score for the reference context.

19. The method of claim 17, further comprising the step of modifying the matching category score based on a category score associated with the content item and a category score for the reference context.

20. The method of claim 17, further comprising the step of modifying the matching relationship score based on a relationship score associated with the content item and a relationship score for the reference context.
